(19) United States
(12) Patent Application Publication
(10) Pub. No.: US 2009/0096136 A1
(43) Pub. Date: Apr. 16, 2009

(54) THIOL-ENE BASED POLY(ALKYLSILOXANE) MATERIALS

(75) Inventors: Craig J. Hawker, Santa Barbara, CA (US); Luis M. Campos, Santa Barbara, CA (US); Ines Meinel, Santa Barbara, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: THE REGENTS OF THE UNIVERSITY OF CALIFORNIA, Oakland, CA (US)

(21) Appl. No.: 12/250,344

(22) Filed: Oct. 13, 2008

Related U.S. Application Data
(60) Provisional application No. 60/979,767, filed on Oct. 12, 2007.

(51) Int. Cl. B29C 59/14; C08G 75/04; C08G 77/04; C08G 63/06; B28B 11/08; C08G 63/195; C08F 2/46

(52) U.S. Cl. 264/483; 528/376; 528/25; 528/361; 528/205; 528/192; 522/172; 264/293; 425/470

(57) ABSTRACT

A stamp is comprised of a thiol-ene polymer, wherein the thiol-ene polymer allows for creation of micro-scale or nano-scale patterns useful in soft or imprint lithography. A patterned thiol-ene polymer is fabricated by casting a thiol-ene mixture onto a patterned mold, curing the thiol-ene mixture to form the patterned thiol-ene polymer, and peeling off the patterned thiol-ene polymer from the silicon mold. A stamp comprised of a thiol-ene polymer may be replicated by exposing the to oxygen plasma to form a hydrophilic mold, exposing the hydrophilic mold to a fluorinating agent under vacuum conditions to form a functionalized surface of the hydrophilic mold, casting a thiol-ene mixture on top of the functionalized surface, photocuring the thiolene mixture to form a replica thiol-ene polymer, and peeling off the replica thiol-ene polymer.

### CROSS REFERENCE TO RELATED APPLICATIONS

This application claims the benefit under 35 U.S.C. Section 119(e) of co-pending and commonly-assigned U.S. Provisional Patent Application Ser. No. 60/979,767, filed on Oct. 12, 2007, Craig J. Hawker, Luis M. Campos and Ines Meinel, entitled “THIOL-ENE BASED POLY(ALKYLSILOXANE) MATERIALS” attorneys' docket number 30794.251-US-P1 (2008-055-1), which application is incorporated by reference herein.

This application is related to the following co-pending and commonly-assigned U.S. patent applications:

U.S. Utility application Ser. No. ______, filed on same date herewith, by Craig J. Hawker, Luis M. Campos and Ines Meinel, entitled “METHOD FOR NON-DESTRUCTIVE PATTERNING OF PHOTONIC CRYSTALS EMPLOYED FOR SOLID-STATE LIGHT EXTRACTION,” attorney's docket number 30794.252-US-U1 (2008-054), which application claims the benefit under 35 U.S.C. Section 119(e) of co-pending and commonly-assigned U.S. Provisional Patent Application Ser. No. 60/979,759, filed on Oct. 12, 2007, by Craig J. Hawker, Luis M. Campos and Ines Meinel, entitled “METHOD FOR NON-DESTRUCTIVE PATTERNING OF PHOTONIC CRYSTALS EMPLOYED FOR SOLID-STATE LIGHT EXTRACTION,” attorney's docket number 30794.252-US-P1 (2008-054);

which applications are incorporated by reference herein.

### BACKGROUND OF THE INVENTION

1. Field of the Invention

This invention relates to patterned thiol-ene polymers useful in soft and imprint lithography, and methods for fabricating the same.

2. Description of the Related Art

(Note: This application references a number of different publications as indicated throughout the specification by one or more superscripted reference numbers, e.g.,^{x}. A list of these different publications ordered according to these reference numbers can be found below in the section entitled “References.” Each of these publications is incorporated by reference herein.)

The vast interest and drive towards miniaturization and microfluidics has led to the development of several moldable materials and technologies.² Soft lithography is among the most promising techniques for the patterning of nano/microstructures on surfaces. However, there are a limited number of reliable materials for soft lithography.³⁻¹⁰ The most widely used is an elastomer comprised of a thermally crosslinked poly(dimethylsiloxane) (PDMS), that is commercially available (Sylgard 184™, Dow-Corning). While this material leads to relatively facile patterning of microstructures, the poor mechanical properties (Young's modulus (YM), ca. 2 MPa)⁷ lead to complications at dimensions below 1 micrometer. A natural extension of this approach was the use of a higher modulus PDMS, namely hard-PDMS or h-PDMS (modulus ca. 8 MPa), and features down to a few nanometers (nm) have been demonstrated.^{4,11,12} The technique to make h-PDMS stamps employs the use of h-PDMS as a thin film on the master to mold the pattern, and the softer PDMS is used as a backplate support for the stamping. The many problems associated with some of the PDMS materials currently available (e.g., processing, stamp deformation, swelling by organic solvents, low temperature resistance, etc.)^{13,14} can inhibit the further development of printing on surfaces, microfluidics, microprocessors, and materials engineering, among others.

### SUMMARY OF THE INVENTION

Currently, there are a limited number of reliable materials for soft lithography or imprint lithography. In general, these materials tend to be either brittle, difficult to make, and/or have very low YM values (1-10 MPa), among other important factors. Thiol-ene photo-polymerizations¹ offer a viable means to use readily available and inexpensive materials, by means of simplistic photochemical cross-linking conditions without the rigorous exclusion of oxygen. The reaction involves the use of compounds with thiols and alkene groups, in the presence of a small amount of a radical photoinitiator, to carry out the cross-linking via radical addition to double bonds and radical-radical recombinations. By appropriately screening the monomer materials, tuning of the physical properties of the stamps should be readily accomplished. Similarly, the manipulation to apply the materials to variable conditions can be easily adjusted by understanding and controlling the effect of the monomer units on the bulk properties. The present invention has discovered that thiolpropyl substituted poly(mercaptopropylmethylsiloxane) (PMMS), is the optimum material for imprint lithography and leads to a variety of composition of matter claims when blended with a series of alkene-functional monomers. The performance of these materials far exceeds current formulations disclosed in the literature and is non-obvious, and the choice of PMMS is critical as it gives a solid patent position for both materials as well as process filings.

Therefore, to overcome the limitations in the prior art described above, and to overcome other limitations that will become apparent upon reading and understanding the present specification, the present invention describes a thiol-ene polymer composition of matter, comprising a reaction mixture of one or more poly-thiol compounds blended with one or more alkene-functional monomers; and a cross-linking between the alkene-functional monomers and the poly-thiol compounds that controls one or more physical properties of the thiol-ene polymer.

The present invention further discloses a method of fabricating the thiol-ene polymer, comprising mixing one or more poly thiol compounds (e.g. PMMS) with one or more alkene-functional monomers, for example, in the presence of less than 0.1% of a radical photoinitiator, and cross-linking the one or more thiols and the one or more alkene-functional monomers, for example via radical addition to double bonds and radical-radical recombinations, thereby forming the thiol-ene polymer. The cross-linking may be achieved through a photochemical process and in a presence of oxygen, or via a thermal process, for example.

The method may further comprise screening alkene functional monomers to control physical properties of the thiol-ene polymer. The physical properties may comprise, for example, a tunable YM, hydro-phobicity or hydro-philicity, or enabling miscibility of the alkene monomers with the thiol compound. The alkene-functional monomers may comprise, for example, one or more of the following: ethylene glycol diacrylate (EGDA), 2,4,6-triallyloxy-1,3,5-triazine (TAOTA), Ethoxylated (4) bisphenol A dimethacrylate (BPADMA), DMAFC6, and DAOFEO. However, other alkene monomers are also possible.

The physical properties are typically controlled by one or more of the following: a composition of the alkene monomers, an alkene monomer to thiol weight to weight ratio (ene:thiol ratio), a structure of the alkene monomers and physical properties of the alkene functional monomers. For example, the physical properties may enable the thiol-ene polymer to be molded into submicron and nano scale features with aspect ratios of up to 5 without collapse of the features. Several different alkene monomers may be blended with the thiol compound, for example, a first composition of one of the alkene monomers may allow the thiol-ene polymer to withstand a stress greater than 1 MPa and a second composition of one of the alkene monomers may allow the thiol-ene polymer to have a strain percentage between 5% and 55%. Specifically, the alkene monomers may comprise BPADMA to increase a stress the thiolene polymer can withstand without breaking, as compared to without the BPADMA, and may further comprise EGDA to increase a flexibility of the thiol-ene polymer as compared to without the EGDA. The alkene monomers may further comprise TAOTA to render the poly thiol compound PMMS and BPADMA miscible.

In addition, a composition of one or more of the alkene monomers may:

(1) enable a hydrophobicity or hydrophilicity for the thiol-ene polymer, which may be characterized by a water contact angle, for example using DMAFC6 or DAOFEO as one of the alkene monomers,

(2) enable the thiol-ene polymer to be cured at temperatures up to at least 225° C.,

(3) render the thiol-ene polymer transparent for wavelengths of light above 300 nm, and/or

(4) render a mixture of the alkene monomers and the poly-thiol compound miscible.

The present invention further discloses an apparatus for use in lithography, comprising a stamp comprised of a patterned thiol-ene polymer, wherein the patterned thiol-ene polymer allows for creation of micro-scale or nano-scale patterns useful in soft or imprint lithography.

The present invention further discloses a method of fabricating a patterned thiol-ene polymer, comprising (a) casting a thiol-ene mixture onto a patterned mold; (b) curing the thiol-ene mixture to form the patterned thiol-ene polymer; and (c) peeling off the patterned thiol-ene polymer from the mold.

The present invention further discloses a method for replicating a stamp comprised of a thiol-ene polymer, comprising exposing a stamp comprised of a thiol-ene polymer to oxygen plasma or ozonolysis to form a hydrophilic mold; exposing the hydrophilic mold to a fluorinating agent to form a functionalized surface of the hydrophilic mold; casting a thiol-ene mixture on top of the functionalized surface; photocuring the thiolene mixture to form a replica thiol-ene polymer; and peeling off the replica thiol-ene polymer from the functionalized surface.

### BRIEF DESCRIPTION OF THE DRAWINGS

Referring now to the drawings in which like reference numbers represent corresponding parts throughout:

FIG. 1A is a schematic showing how the thiol-ene reaction is propagated by steps A and B, and FIG. 1B is a schematic showing the use of poly[(3-mercaptopropyl)methylsiloxane] (PMMS) along with a series of organic-based cross-linking materials.

FIGS. 2A, 2B and 2C are schematics showing the process for making PMMS stamps, wherein FIG. 2A shows the step of casting thiol-ene mixture onto a patterned silicon mold, FIG. 2B shows the step of photocuring with 365 nm wavelength light, and FIG. 2C shows the step of peeling off a patterned stamp.

FIG. 3 shows graphs of tensile stress-strain curves obtained for the materials under investigation (SB1-SB7), plotting static stress in MegaPascals (MPa) vs. static strain (% elongation), wherein the stress rises until the point of breaking the samples.

FIG. 4A is a thermogravimetric analysis (TGA) plot of the sample blends (SBs), plotting weight (%) vs. temperature (° C.), wherein FIG. 4B is a differential scanning calorimetry (DSC) plot of the SBs, plotting heat flow in (W/g) vs. temperature (° C.), showing the temperature region before they begin to decompose, as observed by TGA.

FIG. 5 shows UV-Visible (UV-Vis) absorption spectra of the cross-linked blends with film thicknesses 1-2 mm, plotting absorbance in arbitrary units (a.u) vs. wavelength (nm), wherein the inset shows the absorption spectra (also plotting absorbance in a.u vs. wavelength (nm)), in chloroform, of the radical photoinitiator DMPAP and focuses on the n, π* transition region.

FIG. 6A is a Scanning Electron Microscope (SEM) image of the master mold, and FIGS. 6B-6G are SEM images of stamps cast on the master mold, wherein the stamp in FIG. 6B is comprised of SB2, the stamp in FIG. 6C is comprised of SB3, the stamp in FIG. 6D is comprised of SB4, the stamp in FIG. 6E is comprised of SB5, the stamp in FIG. 6F is comprised of SB6, and the stamp in FIG. 6G is comprised of SB7.

FIGS. 7A-7E are SEM images of alumina templates with pore diameter circa (ca.) 55 nm, having aspect ratios of 2 (FIG. 7A), 3 (FIG. 7B), 4 (FIG. 7C), 5 (FIG. 7D), and 5.8 (FIG. 7E), and the stamps in FIGS. 7F-7J were comprised of SB1, wherein the stamp of FIG. 7F uses the alumina template of FIG. 7A, the stamp of FIG. 7G uses the alumina template of FIG. 7B, the stamp of FIG. 7H uses the alumina template of FIG. 7C, the stamp of FIG. 7I uses the alumina template of FIG. 7D, and the stamp of FIG. 7J uses the alumina template of FIG. 7E.

FIGS. 8A-8D are SEM images of the stamps comprised of SB1, wherein the stamp of FIG. 8A uses the alumina template of FIG. 7B, the stamp of FIG. 8B uses the alumina template of FIG. 7C, the stamp of FIG. 8C uses the alumina template of FIG. 7D, and the stamp of FIG. 8D uses the alumina template of FIG. 7E.

FIG. 9 is a graph of X-ray photoelectron spectroscopy (XPS) spectra, plotting relative intensity v. binding energy in electron Volts (eV), showing the elemental composition at the surface of SB2 (bottom curve), SB2-O₂ (center curve), and SB2-F (top curve).

FIG. 10A is a SEM image of SB2-F (FIG. 10A) and FIG. 10B is an SEM image of SB2 using SB2-F as a mold (FIG. 10B).

FIG. 11 is a schematic of a replica molding process with and without a fluorinated release layer in SB2.

FIG. 12 is a flowchart illustrating a method of the present invention.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Technical Description

In a radical approach, the present invention seeks to optimize not only the physical properties of PDMS-based stamp materials, but also the process by which they are made. It is of utmost importance to develop materials that can be easily blended to yield high fidelity composites in a fast and reliable fashion with viable means of tuning their bulk properties. Thus, the present invention allows the user to manufacture multiple stamps in a short period of time (within minutes), for parallel printing over large areas, and at very low cost. In this regard, thiol-ene chemistry offers (1) a wealth of versatility for the incorporation of molecules that can be used to tune the bulk properties of the material and (2) the ease of photocuring in the presence of oxygen.^{3,15} Herein, the present invention describes the use of a polysiloxane-based material that is photochemically crosslinked, at ambient conditions, with various compounds to yield patternable materials that have tunable physical properties.

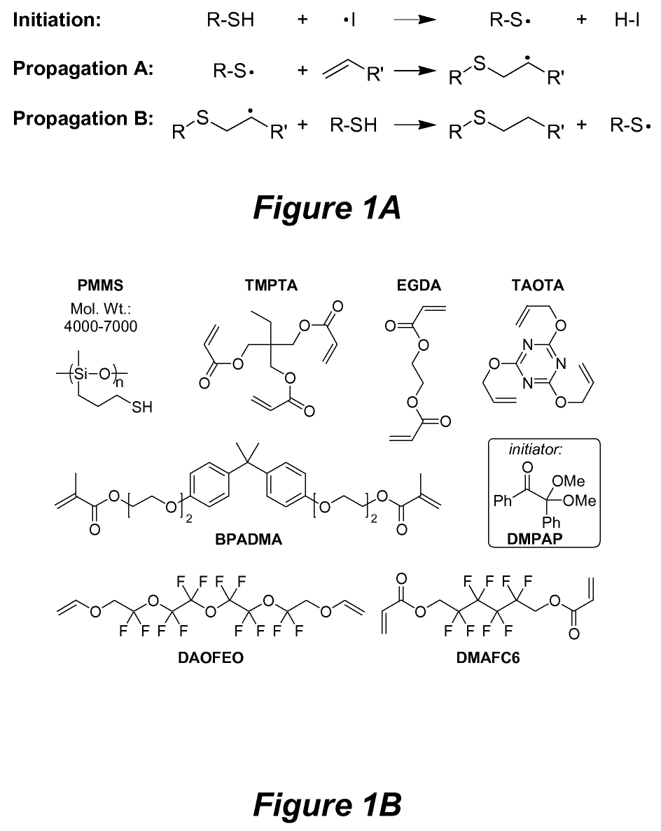

The polymerization/cross-linking of thiol-enes can be triggered photochemically (or thermally) by the use of little or no radical initiator.¹⁵ Furthermore, the reaction can be carried out without any deoxygenation, which otherwise would inhibit the reactivity of the radicals generated in other photocurable systems.^{7,9} The thiol-ene reaction is propagated by steps A and B shown in FIG. 1A, wherein R and R′ are any alkyl substituents, H is hydrogen, I is any radical initiator and the “dots” throughout are the radical centers. In order to take advantage of the physical and mechanical properties of PDMS-based materials, along with the versatility of incorporating various alkene cross-linkers with thiol-ene chemistry,³ the present invention used poly[(3-mercaptopropyl)methylsiloxane] (PMMS) along with a series of organic-based cross-linking materials (see FIG. 1B).

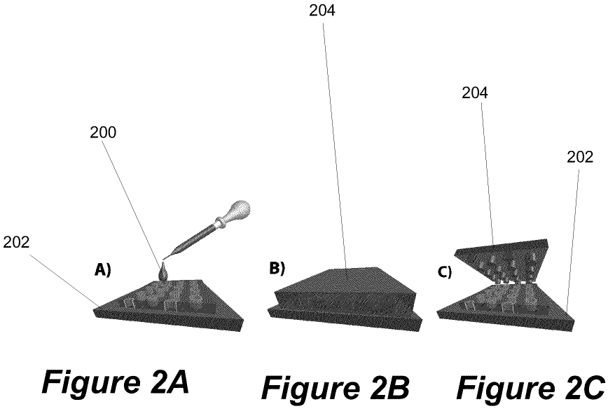

The general procedure to make the stamps involved the mixing of the polythiol such as PMMS and the alkene cross-linker(s) in FIG. 1B along with <1 wt. % of the initiator 2,2-dimethoxy-2-phenylacetophenone (DMPAP) to form a thiol-ene mixture. FIG. 2A shows how the thoroughly mixed solution 200 (the thiol-ene mixture) was then cast (or deposited) on the patterned mold 202 (for example a patterned silicon mold having 200 nm features or a patterned alumina template having sub-100 nm features), and then cured, for example with a 365 nm lamp for 2 minutes (see FIG. 2B). Thus, the cured solution (cured thiol-ene mixture) are patterned thiol-ene polymer stamps 204 which were removed by carefully peeling the stamp 204 from the mold 202 (FIG. 2C). In order to minimize the stamp 204 adhesion to the silicon molds 202 and alumina templates during testing, a releasing agent was used to coat the silicon masters 202, (tridecafluoro-1,1,2,2-tetrahydrooctyl)trichlorosilane (Cl3 SiCH2CH2[CF2]5CF3, TDFOCS).

Physical and Mechanical Characteristics

TABLE 1
Summary of Physical Characteristics of the Thiol-ene Blends
from FIG 1B.

| | thiol-ene | weight | Ratio | Modulus | ^{c}contact |
|---|---|---|---|---|---|
| Label^{a} | mixture | ratio | (ene:thiol) | (MPa)^{b} | angle (°) |
| SB1 | PMMS | 3 | 2.2 | 41.0 | — |
| | TMPTA | 4 | | | |
| SB2 | PMMS | 6 | 1.4 | 24.2 | 60 |
| | BPAdMA | 1 | | | |
| | TAOTA | 4 | | | |
| SB3 | PMMS | 7 | 1.2 | 15.6 | 61 |
| | EGDA | 2 | | | |
| | BPAdMA | 1 | | | |
| | TAOTA | 2 | | | |
| SB4 | PMMS | 8 | 1.1 | 20.6 | 62 |
| | BPAdMA | 1 | | | |
| | TAOTA | 4 | | | |
| | DMAFC6 | | | | |
| | | 0.6 | | | |
| SB5 | PMMS | 8 | 1.1 | 13.9 | 64 |
| | EGDA | 2 | | | |
| | BPAdMA | 1 | | | |
| | TAOTA | 2 | | | |
| | DMAFC6 | | | | |
| | | 0.6 | | | |
| SB6 | PMMS | 8 | 1.2 | 22.7 | 59 |
| | BPADMA | 4 | | | |
| | TAOTA | 1 | | | |
| | DAOFEO | 1 | | | |
| SB7 | PMMS | 8 | 1.2 | 20.7 | 68 |
| | EGDA | 2 | | | |
| | BPADMA | 1 | | | |
| | TAOTA | 2 | | | |
| | DAOFEO | 1 | | | |

^{a}SB = sample blend.
^{b}Young's modulus.
^{c}Water.

The stamp materials were screened systematically, without any patterns from the silicon mold, by blending the cross-linkers with PMMS using various weight to weight ratios. After photocuring, the materials were tested for strength and flexibility, and the best candidates were submitted to stress-strain tests to measure their respective modulus. Table 1 shows the blended materials, labeled as sample blend 1 (SB1), sample blend 2 (SB2), sample blend 3 (SB3), sample blend 4 (SB4), sample blend 5 (SB5), sample blend 6 (SB6), and sample blend 7 (SB7) that gave the best results, along with the measured modulus of each sample. Among all the potential stamp materials, SB1 had the highest modulus at 41.0 MPa. While this blend gave a tough and unbendable material, the present invention decided to not pursue making stamps using the silicon masters due to the potential to break the molds while peeling or during curing. However, SB1 was later used with the alumina templates. The rest of the blends, SB2-SB7, yielded materials with great characteristics for soft lithography, showing that the modulus can be tuned depending on the composition, structure, and properties of the cross-linkers.

In these materials, miscibility played an important role in the mixing of the cross-linkers with PMMS. For example, both PMMS and ethoxylated (4) bisphenol A dimethacrylate (BPADMA) were immiscible and could not be used solely as a couple in a blend. However, upon addition of 2,4,6-triallyloxy-1,3,5-triazine (TAOTA), all three components mixed well. While higher amounts of BPADMA could be incorporated without phase separation (e.g. SB2), some of the desired physical properties, such as flexibility, appeared to be sacrificed. The blends reported in Table 1 represent only the materials that were found to be more promising for applications in soft lithography, and potentially in microfluidics. The present invention recognizes that many other combinations of varied ene-to-thiol ratios could have been explored, however the present invention decided to focus on the listed SBs to compare and contrast the resulting materials properties inherent to the blended components.

All of SB2-SB7 contain BPADMA as a key cross-linking component. This compound was used to make the materials stronger in a similar way as the previously reported materials based on pentaerythritol tetrakis(3-mercaptopropionate) (PTMP).³ Thus, it was used as a re-enforcer in all blends. A perfect example of such characteristics was observed in the blend of PMMS with TAOTA, which yielded a material with reasonably good physical characteristics. However, by optimizing such a blend and incorporating BPADMA, the resulting YM of 24.2 MPa was achieved in SB2. In order to decrease the modulus to make a softer stamp, a short and flexible cross-linker was incorporated, namely ethylene glycol diacrylate (EGDA, see FIG. 1B). In SB3, EGDA reduced the modulus to 15.6 MPa. However, the product of a mixture of only PMMS and EGDA was slightly flexible, but undesirably more brittle than SB2.

While previously reported PDMS materials can yield materials having tensile modulus ranging from <1-8 MPa, they are synthesized by very different means, under time-consuming conditions, and the resulting materials have several limitations. The PMMS materials may have the limitation of using miscible components. But the possibilities for incorporating a multiple number of components are vast, the chemistry involved is extremely simple, and the curing process is exceptionally fast.

In an attempt to decrease the surface energy of the materials as well as decreasing solvent uptake, the present invention sought to incorporate the fluorinated cross-linkers DAOFEO and DMAFC6 (FIG. 1B). It has been shown that cross-linked perluoropolyethers (PFPEs) can yield materials with low surface energy and YM of circa (ca.) 4 MPa⁶ and 10.5 MPa.⁹ Unfortunately, the fluorinated cross-linkers in FIG. 1B were immiscible with PMMS and, similar to BPADMA, they could only be incorporated as minor components within the blends. When integrated with PMMS, TAOTA, and BPADMA, DMAFC6 resulted in a material having a YM of 20.6 MPa (SB4). The amount listed in Table 1 was the maximum quantity that the mixture could take without phase separation. When added in larger quantities, the solution became turbid and no longer miscible. Compared to SB2, the blend with similar components, SB4 resulted in a material with a lower YM and a very similar water contact angle (the larger the water contact angle, the more hydrophobic the surface). It is not surprising that the YM decreased, since DMAFC6 is a flexible cross-linking unit. The contact angle is an indication that not many fluorine groups are exposed to the surface to render it hydrophobic. The incorporation of DMAFC6 in SB5 had a similar effect on the properties of the material. The YM decreased, as compared to SB3, and the water contact angle was not noticeably different.

The present invention also uses a fluorinated cross-linker with a different core than DMAFC6, namely DAOFEO, wherein the core in DMAFC6 comprises all carbon-carbon bonds, and the core in DAOFEO comprises carbon-carbo-oxygen bonds. DAOFEO was incorporated in slightly higher amounts than DMAFC6 in the respective blends (see SB6 and SB7). However, in both SB6 and SB7, the water contact angle was not changed to the point of hydrophobicity. The change was most notable in SB7, having a water contact angle value of 68°.

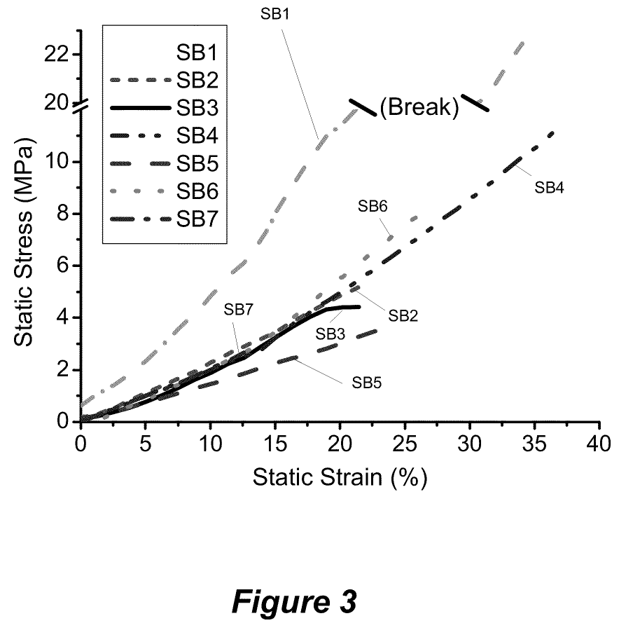

The tensile stress-strain curves for the materials are shown in FIG. 3 and only extend to the break-point with respect to the percent elongation. Choi and Rogers have reported a comparison between the elongation at break in h-PDMS, soft-PDMS (s-PDMS), and a photocurable PDMS (hv-PDMS).⁷ All these three materials break at a point <1.0 MPa (s-PDMS at ca. 0.4 MPa, h-PDMS at ca. 0.6 MPa, and hv-PDMS at ca 1.0 MPa), which is noticeably less than the PMMS-based materials. An interesting feature, however, is that the PMMS systems break at strain percentages lower than the hv-PDMS (ca. 55%) and s-PDMS (ca. 70%), but higher than h-PDMS (ca. 5%). Such mechanical properties render PMMS materials with flexibility and stability for several applications. Furthermore, having the control of easily varying the molecular properties of the cross-linkers, to control the bulk mechanical properties, provides the PMMS systems with an advanced level of modulation that is not easily achieved with PDMS materials.

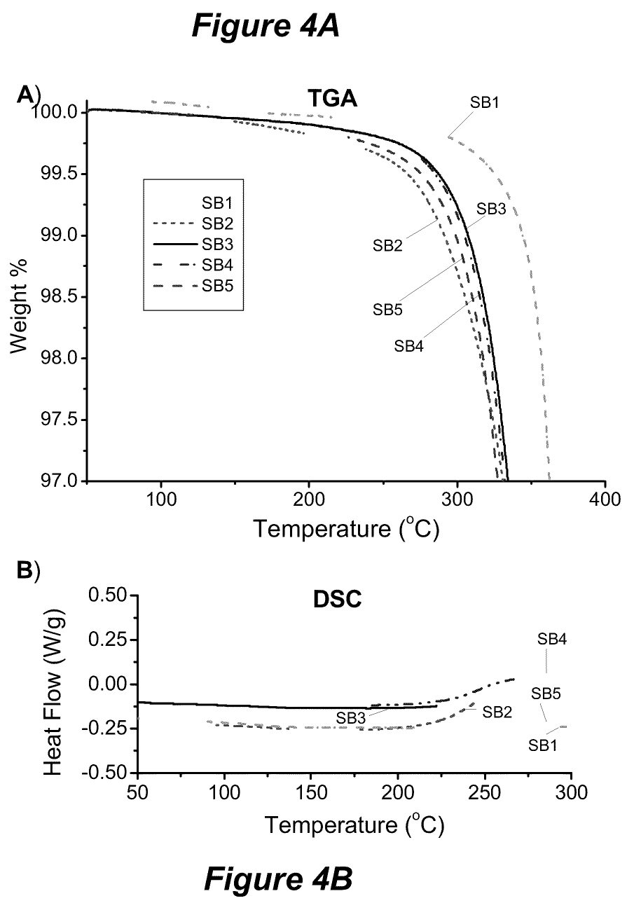

With the potential to use the PMMS materials to transfer patterns using thermally curable components, such as embossing,^{16,17} both thermogravimetric analysis (TGA) and differential scanning calorimetry (DSC) were carried out in order to obtain information regarding the thermal stability of the SBs (see FIGS. 4A and 4B). The TGA plot shows a similar pattern of decomposition for the PMMS blends. Decomposition begins to take place near 300° C., a value comparable to that of Sylgard 184.¹⁸ Above 300° C., the PMMS blends quickly decompose. Furthermore, within the temperature range from 50° C. to 300° C., the PMMS blends do not undergo any phase transitions (see FIG. 4B). Minor changes in the heat flow begin to take place around 250° C. However, these minimal changes do not constitute phase changes, which are generally characterized by larger variations in the heat flow. Such physical characteristics reveal that the PMMS blends are thermally stable and should allow for thermal curing up to 225° C. to be potentially used for pattern transfer.

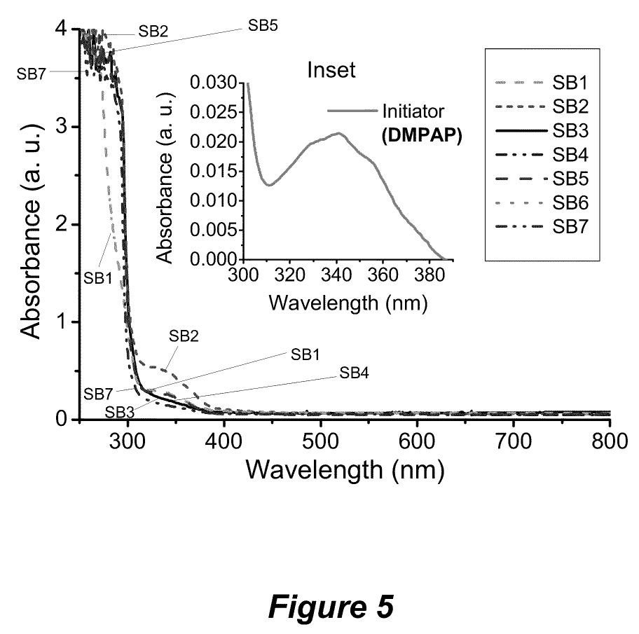

An alternative to thermally curing the stamped material to achieve pattern transfer is photochemically curing the stamped material, as in step-and-flash imprint lithography (SFIL).^{19,20} Thus, in case photo-curing is desired for the SBs, the light absorption characteristics of each of the stamp materials was characterized. FIG. 5 shows the Ultra-Violet to visible (UV-Vis) absorption spectra of the cross-linked blends. All materials are transparent above 300 nm and contain a small shoulder between 300 and 400 nm, which may potentially arise from the n,π* transition of the residual radical photoinitiator DMPAP. The acetopheneone DMPAP is usually added to the blends in quantities less than 0.1%. The assignment is based on the spectrum of DMPAP in solution (see Inset in FIG. 5). These PMMS based materials are nearly as good as s-PDMS and h-PDMS, which are transparent to light above the range of 250-300 nm.¹⁰ The newly developed perfluoropolyether (PFPE) stamps, by Rogers and co-workers, are transparent above ca. 350 nm (40% transmission at 350 nm).¹⁰

Pattern Transfer from Master Mold

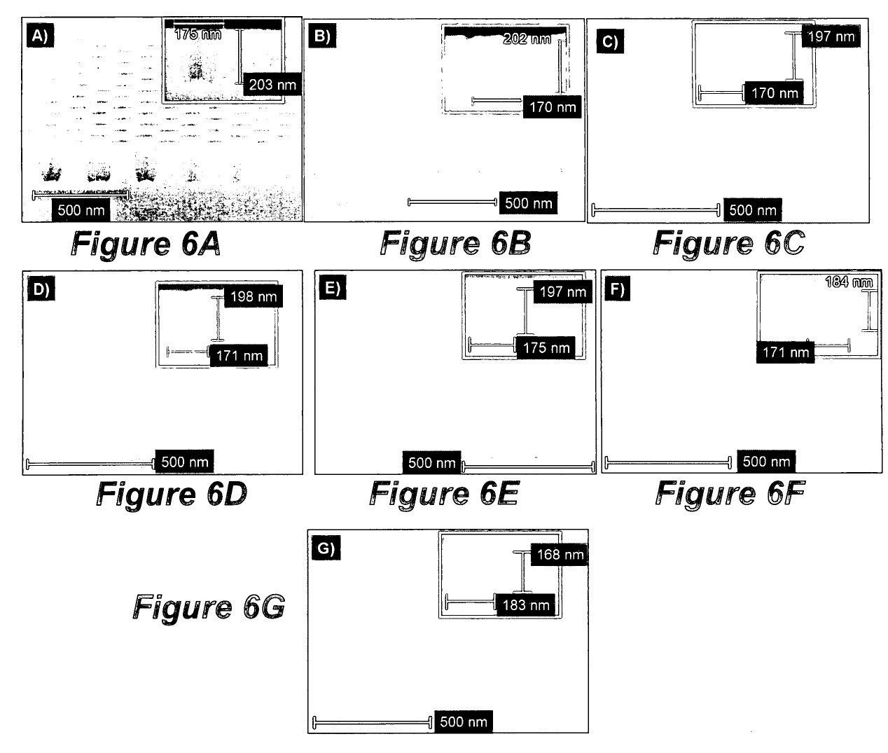

The silicon master molds used were patterned with holes in a hexagonal pattern having a period of 250 nm and hole dimensions of ca. 175 nm diameter by 200 nm depth. The silicon master molds were treated with the fluorinating agent TDFOCS to decrease the mold's surface energy and preserve the molds for multiple uses. However, the present invention also noticed that the materials did not stick too much with other non-fluorinated molds. Thus, the fluorinating agent was simply used as a preventive measure during testing. FIG. 6A shows the SEM image of the silicon mold. The thiol-ene SB2 mixture was then cast on the mold as in FIG. 2, and a glass backing-plate was used to sandwich the thiol-ene mixture using a ca. 1 millimeter (mm) spacer. The spacer and glass backing-plate (microscope slide) ensured a homogeneous thickness of the resulting stamp. After photo-curing for 2 minutes with 365 nm wavelength light, the glass backing-plate was removed and the stamp was peeled from both the glass and mold.

In FIGS. 6B-6G, the SEM images of the blends SB2-SB7 are shown. The posts from the stamps that best resemble the master mold are those of SB2 (shown in FIG. 6B). The inset in the image of FIG. 6B shows that the posts have a height of ca. 200 nm and a diameter of 170 nm. Using the material with a lower YM, SB3, resulted in posts that seem to sufficiently fill the holes of the master, but with features that were not as fine as the ones in SB2. The images in FIG. 6C show that the posts of SB3 are more rounded at the top, where SB2 holds a more cylindrically-defined shape.

In SB4 and SB5 (shown in FIGS. 6D and 6E, respectively), the present invention observed a similar effect to the materials having the higher and lower YM. The less round features observed in SB2 seemed to slightly decrease in SB4 (compare FIGS. 6B and 6D). In both the SB2 and SB4 cases, the posts have similar dimensions, but the posts of FIG. 6D are slightly more round at the top. Comparing the images in FIGS. 6C and 6E, it can be observed that the material from SB5 behaves quite similar to that of SB3, leading to posts of similar features. Lastly, the fluorinated cross-linker DAOFEO led to drastic changes in the characteristics of the posts. It seems that for both blends SB6 and SB7 the pattern replication was not efficient, leading to posts of heights of ca. 180 nm and ca. 170 nm, respectively.

Sub-100 nm Features

Achieving sub-100 nm features using the current materials available for soft lithography has proven to be extremely challenging.²¹ Therefore, the present invention has prepared alumina templates having pores of ca. 55 nm diameter and varying depths of 110-320 nm. McGehee and co-workers have shown that composite stamps of PMMA/PDMS can be made to replicate those features.²¹ However, upon making the stamps through a very elaborate process, the alumina template is dissolved in order to obtain the stamp for soft lithography. Similarly, Yang and co-workers have studied the correlation between achieving high aspect ratios and the YM of the materials, with ca. 0.5-1 μm diameter posts.²² The present invention's efforts were aimed at simplifying the stamp-making process with only one composition of materials, without destroying the master, and at the same time achieving sub-100 nm features with high aspect ratios.

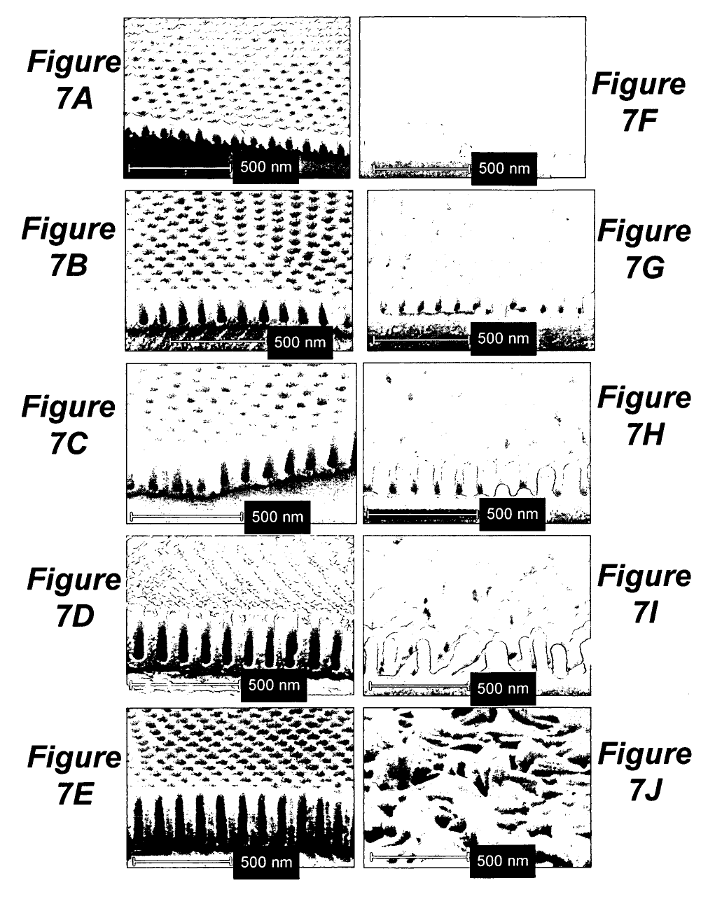

First, the alumina template was treated with the fluorinating agent, TDFOCS, to facilitate the release properties. After following the procedure in FIG. 2 to prepare the stamps, the resulting pattern was characterized by SEM. The SEM images of the alumina templates are shown in FIGS. 7A-7E. In order to test the limitations of the thiol-ene materials in the sub-100 nm regime, the alumina templates were prepared having pores of ca. 55 nm diameter and varying heights from ca. 110-320 nm, thus yielding aspect ratios from 2-5.8. When stamps comprised of SB2 were prepared (modulus=24 MPa, physical toughness=53 MPa),²³ the highest aspect ratio obtained without the collapse of the posts was 3 (FIG. 7H).

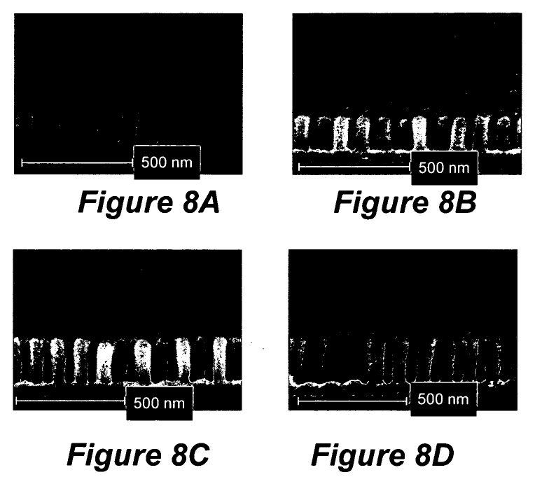

However, the use of SB1, having a higher modulus of 41 MPa and physical toughness of 341 MPa, yielded posts of aspect ratio of up to 5 without any collapse, as shown in FIG. 8C, using the mold in FIG. 7D. At the higher aspect ratio of 5.8 (the mold from FIG. 7E), the posts began to collapse, though still maintaining some free-standing posts, as evidenced in FIG. 8D. The present invention attributes the achievement of higher aspect ratio features to the modulus and physical toughness of SB1 as compared to SB2.

FIGS. 8A-8D are SEM images of the stamps comprised of SB1, wherein the stamp of FIG. 8A uses the alumina template of FIG. 7B, the stamp of FIG. 8B uses the alumina template of FIG. 7C, the stamp of FIG. 8C uses the alumina template of FIG. 7D, and the stamp of FIG. 8D uses the alumina template of FIG. 7E.

Thus, FIGS. 2A-2C, FIGS. 6B-6G, FIGS. 7F-7J, and FIGS. 8A-8D illustrate an apparatus for use in lithography, comprising a stamp comprised of a patterned thiol-ene polymer, wherein the patterned thiol-ene polymer allows for creation of micro-scale or nano-scale patterns useful in soft or imprint lithography.

Surface Functionalization of the Thiol-Ene Materials

Given that PDMS materials can be modified at the surface to become hydrophilic by exposure to oxygen plasma, leading to hydroxy functionality,²⁴ the present invention decided to perform the same treatment to the present invention's materials in order to later functionalize with the same fluorinating agent that was used for the silicon masters. In order to test the surface treatment, a non-patterned, 1 mm-thick film of SB2 was exposed to O₂ plasma for 15 seconds. Water contact angle measurements of SB2 yielded an angle <17°, as opposed to the original angle of 60°. After exposing the surface to Tridecafluoro-1,1,2,2-tetrahydrooctyl)trichlorosilane (TDFOCS) vapor under line vacuum for 20 minutes, the water contact angle was measured at 103°, rendering it hydrophobic. Similarly, the contact angle in SB3 changed from 61° to <18° after O₂ plasma treatment, and finally to 102° after functionalizing the surface with TDFOCS.

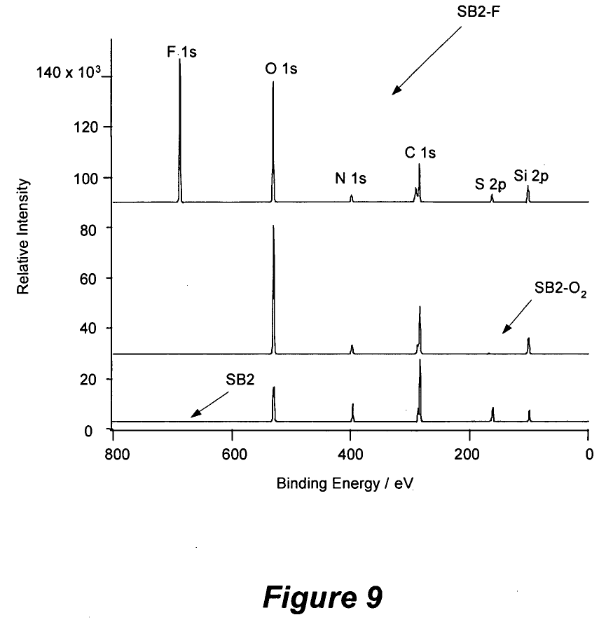

The surface treatment process for SB2 was also characterized by XPS. This technique allowed for the identification of the elements present at the surface, before exposure to O₂ plasma (SB2 curve), after exposure to O₂ plasma (SB2-O₂ curve), and after surface functionalization with TDFOCS (SB2-F curve). FIG. 9 shows the evolution of the spectra at each step. From the composition of the blend, SB2 shows the presence of Carbon (C), Nitrogen (N), Oxygen (O), Sulphur (S), and Silicon (Si). After O₂ plasma, the intensity of the oxygen peak noticeably increased in SB2-O₂. This step is in accord with the observations by XPS when making hydrophilic PDMS stamps.²⁴ Finally, the incorporation of the covalently bound TDFOCS is evident by the appearance of a Fluorine peak in the SB2-F curve.

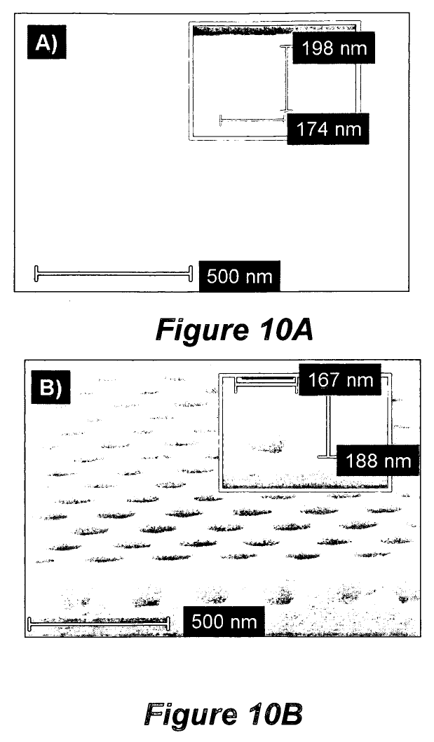

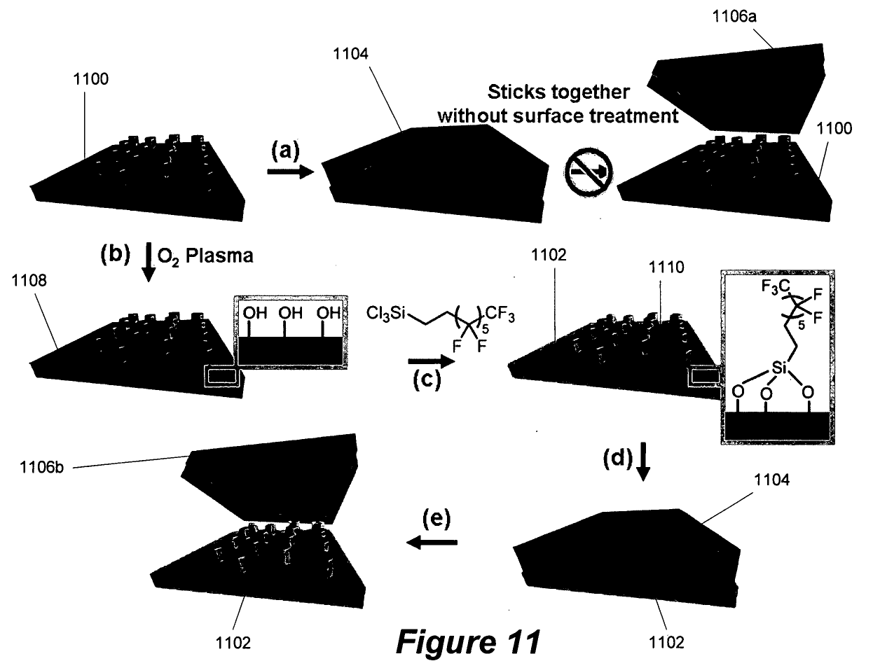

Given that O₂ plasma conditions can be detrimental to patterned polymer surfaces, the present invention exposed a patterned SB2 stamp to the same conditions as above. The SEM of the resulting stamp, SB2-F, is shown in FIG. 10A. The main difference is that the posts became slightly round at the top of the cylinders. To test the extent of the effect of the fluorinated layer, both an untreated stamp 1100, SB2, and a treated stamp 1102, SB2-F, were cast with the thiol-ene mixture SB2 1104, as shown in FIG. 11. When the SB2 solution 1104 was cast on the SB2 patterned stamp 1100 and followed by photocuring, as represented by (a) in FIG. 11, the SB2 patterned stamp 1100 and photocured SB2 replica stamp 1106a layers could not be separated, as shown by (b′) in FIG. 11. Both were noticeably covalently bound.

However, following the release layer treatment with the fluorocarbon to yield SB2-F 1102, the cured SB2 stamp 1106b was easily peeled off. Specifically, (b) in FIG. 11 shows the step of exposing a patterned SB2 stamp 1100, acting as a mold, to O₂ plasma (or ozonolysis, for example) for 15 seconds to form a hydrophilic SB2 stamp mold 1108, (c) in FIG. 11 shows the step of exposing the hydrophilic stamp mold 1108 to TDFOCS vapor for 20 minutes under vacuum to yield “SB2-F” 1102 to form a functionalized surface 1110 of the hydrophilic mold 1102, (d) in FIG. 11 shows the step of casting (or depositing) thiol-ene mixture SB2 1104 on top of the SB2-F 1102 (on the functionalized surface 1110), and photocuring the thiol-ene mixture 1104 to form a replica SB2 stamp 1106b, and (e) in FIG. 11 shows the step of peeling off the SB2 replica stamp 1106b. The patterned stamp 1100 and 1106a, 1106b could be comprised of any thiol-ene polymer, and the present invention is not limited to the use of TDFOCS, for example other fluorinating agents could be used. The functionalized surface may be a hydrophobic surface, for example.

The process highlighted in FIG. 11 should essentially yield stamps with holes as in the master mold (shown in FIG. 6A). The stamp in the SEM image of FIG. 10B has holes having a diameter ca. 170 nm and a well depth ca. 190 nm, and resembles the master mold shown in FIG. 10A. Furthermore, from the SEM images in FIG. 10A, one can clearly see that there were no noticeable differences between the thiol-ene stamp with holes and the master silicon wafer. While the process of replicating the original silicon master yields small differences in the volume of the holes, the cost difference to make multiple molds of silicon is much greater and time consuming than it is to make the thiol-ene molds. Thus, the present invention has shown that using thiol-ene chemistry to make multiple replicas of the master mold is not only extremely economic, but very fast and easy, and greater quality of the materials has been gained, as compared to the current resources available for making stamps.

Process Steps

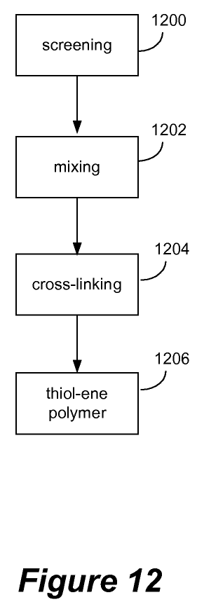

FIG. 12 illustrates a method for fabricating a thiol-ene polymer.

Block 1200 represents the step of screening alkene functional monomers to control physical properties of the thiol-ene polymer. The physical properties may comprise, for example, a tunable YM, hydro-phobicity or hydro-philicity, or enabling miscibility of the alkene monomers with the thiol compound. The alkene-functional monomers may comprise, for example, one or more of the following: EGDA, TAOTA, BPADMA, DMAFC6, and DAOFEO. However, other alkene monomers are also possible.

The physical properties are typically controlled by one or more of the following: a composition of the alkene monomers, an alkene monomer to thiol weight to weight ratio (ene:thiol ratio), a structure of the alkene monomers and physical properties of the alkene functional monomers. For example, the physical properties may enable the thiol-ene polymer to be molded into submicron and nano scale features with aspect ratios of up to 5 without collapse of the features. Several different alkene monomers may be blended with the thiol compound, for example, a first composition of one of the alkene monomers may allow the thiol-ene polymer to withstand a stress greater than 1 MPa and a second composition of one of the alkene monomers may allow the thiol-ene polymer to have a strain percentage between 5% and 55%. Specifically, the alkene monomers may comprise BPADMA to increase a stress the thiolene polymer can withstand without breaking, as compared to without the BPADMA, and may further comprise EGDA to increase a flexibility of the thiol-ene polymer as compared to without the EGDA. The alkene monomers may further comprise TAOTA to render the poly thiol compound PMMS and BPADMA miscible.

In addition, a composition of one or more of the alkene monomers may:

(1) enable a hydrophobicity or hydrophilicity for the thiol-ene polymer, which may be characterized by a water contact angle, for example using DMAFC6 or DAOFEO as one of the alkene monomers.

(2) enable the thiol-ene polymer to be cured at temperatures up to at least 225° C.,

(3) render the thiol-ene polymer transparent for wavelengths of light above 300 nm, and/or

(4) render a mixture of the alkene monomers and the poly-thiol compound miscible.

Block 1202 represents the step of mixing one or more poly thiol compounds with one or more alkene-functional monomers, for example, in the presence of less than 0.1% of a radical photoinitiator. The poly-thiol compounds may comprise thiolpropyl substituted poly(mercaptopropylmethylsiloxane) (PMMS), wherein the PMMS may have a molecular weight in a range 4000-7000.

Block 1204 represents the step of cross-linking the one or more thiols and the one or more alkene-functional monomers, for example via radical addition to double bonds and radical-radical recombinations, thereby forming the thiol-ene polymer. The cross-linking may be achieved through a photochemical process and in a presence of oxygen, or via a thermal process, for example.

Block 1206 represents the final result of the method, a thiol-ene polymer composition of matter, comprising a reaction mixture of one or more poly-thiol compounds blended with one or more alkene-functional monomers; and a cross-linking between the alkene-functional monomers and the poly-thiol compounds that controls one or more physical properties of the thiol-ene polymer. However, the present invention does not limit fabrication of the thiol-ene polymer by this method.

Utility of the Thiol-Ene Based Elastomer

The thiol-ene based elastomer has excellent transparency, UV and thermal-durability, and hydrothermal stability. Thus, it is a suitable material for aerospace industry. For example, its composite with a nanoscale carbon material is promising for anti-static discharge applications, conductive adhesion, gaskets, electromagnetic shielding, and face panels of a rocket.

The main constituent of this thiol-ene based elastomer is polysiloxane which has excellent durability against oxygen induced degradation observed in most elastomeric materials. In addition, it is durable against UV and unfiltered sunlight which cause serious damage in conventional materials. Furthermore, since this material is thermally stable, it is possible to use it around the mechanical members of combustion engines which are subject to heat with the air serving as a heat insulating agent. Also, this polymer has excellent adhesion to various materials, and it does not require additional organic adhesion which tends to deteriorate easily. It is also possible to apply small amount of additives to improve flame retardancy, electromagnetic shielding properties, thermal conductivity, adiabaticity, mechanical strength, adhesiveness, and impact resistance.

For example, when the thiol-ene based elastomer is used as an adiabator, super-thermally durable organic/inorganic additives can be applied to improve its adhesiveness, processability, and mechanical strength, forming a light weight adiabatic rubber with almost no heat-shrinkage or cracking. By tuning the amount of silane moiety and functional groups, it is possible to tune the thiol-ene based elastomer's inherent crosslinking, having a direct effect on mechanical properties such as elongation at break, tensile and compression moduli, ductility and thermal expansion.

Furthermore, the low viscosity allows for ease of coating on various types of surfaces, for example, as a protective coating. For example, the thiol-ene elastomer could be used as a coating layer on an electronic device together with a thixotropic agent like an aerogel. This coating then shows excellent UV and thermal-durability, oxygen resistance, transparency, and adhesiveness. This surface protecting layer can be suitable for photovoltaic cells, and as an encapsulant of light emitting devices and light receiving elements. This layer serves as a protective layer for the ambient elements and inhibits chemical deterioration.

Furthermore, it is possible to use the said thiol-ene composition as a flame retardant elastomer by adding SbO₃, Al₂O₃, halogenated compounds, anti-oxidants. Adding carbon black or silver powder makes it a conductive paste or an electromagnetic shielding material.

When some filler is added, by tuning this thiol-ene elastomer's molecular weight and/or by adding some thixotropic agent, coating properties and sedimentation of the filler can be controlled. Furthermore, by introducing phenyl moieties or other functional groups, its thermal durability, adhesiveness, and mechanical property can be easily controlled.

Thus, this thiol-ene elastomer can be used for a barrier film for organic electronics, patterning photonic crystals on photovoltaic modules for enhanced light trapping, pattering photovoltaic top films to achieve self cleaning effect(s), as a mechanical re-enforcer for multilayers, for flexible, transparent films, lighting, materials for aircraft, rocket, furnace, oven, or building materials. Also, the thiol-ene composition of the present invention is good as a thin, light guide material, as a scaffold for cultures of biological media, as a Micro-Electro-Mechanical Systems (MEMS) material, as a material for diagnostic microfluidics, as a nano-imprint material, as an encapsulant of Light Emitting Diodes (LEDs), and as a material for a liquid crystal back light, etc.

The thiol-ene elastomer according to the present invention cures rapidly in air, and hence attains high productivity and throughput for industrial processing, enabling processing in a wide range of industrial applicability. Owing to its tunable mechanical properties and elastomeric character, it makes a suitable material for high fidelity nanopattern transfer. Therefore, the thiol-ene elastomer according to the present invention makes it possible to provide high-quality products with a small number of manufacturing steps at a lower cost in the fields such as the nanoimprint lithography, submicron shaping, processing and patterning.

In the field of semiconductors and electronic devices, the thiol-ene elastomer makes it possible to replicate patterns by a simple process, for example, complex side wall patterns of ultra-high-density printed wiring boards, organic electro-luminescent (EL) display panel circuits, and optical integrated circuits, etc.

In the field of optical devices, the thiol-ene elastomer can provide a highly transparent, thin film capable of increasing the luminance of liquid crystal display devices and organic EL displays by forming fine projections in a light guide plate, a polarizing film, and an anti-reflection film, etc.

In the field of optical communications devices, the thiol-ene elastomer can be applied to fine waveguide circuits, wavelength filters, and minute lasers by utilizing photonic crystal technology. In optical devices in which a photonic crystal is provided on an LED, the thiol-ene elastomer makes it possible to provide high-luminance light-emitting devices in a simple manner.

In the field of recording media, the thiol-ene elastomer can be suitably used in a patterned medium methodology in which a magnetic surface layer of a magnetic recording medium is divided on a track-by-track basis. For example, a non-magnetic material layer (e.g. the thiol-ene elastomer) is patterned by pressing a high-temperature die having projection/recess patterns against the non-magnetic material, according to the present invention, followed by cooling. Then, a magnetic material layer is formed so as to fill in the recesses of the projection/recess patterns of the non-magnetic material layer (e.g. the thiol-ene elastomer). This method makes it possible to manufacture, with a simple process, next generation optical discs, such as High Definition-Digital Versatile Discs (HD-DVD), Blu-ray Discs (BD), next-next generation optical discs (terabyte DVD), etc. For example, referring to FIG. 2A, the mold 202 could be a high temperature die and a non-magnetic layer (the thiol-ene mixture 200) could be cast on the mold 202. Next, the non-magnetic layer 200 could be cured to form a stamp 204, as shown in FIG. 2B, which is peeled from the mold 202. The non-magnetic stamp could be used to pattern magnetic layers or DVDs.

Furthermore, since the thiol-ene elastomer is transparent and cures under mild conditions, it is superior in fine structure transferability in the chemical (fluid) field and the biotechnology field. The elastomer can be suitably used for separation, reaction, and detection (e.g. in DNA chips, protein chips, and separation chips), in members for regenerative medicine (cell culture sheets and 3D cell culture), microreactors, micromixers, and biosensors, etc.

In the MEMS field, the thiol-ene polymer can be suitably used for processing in manufacture of actuator components, which is part of the micro three-dimensional (3D) structure processing technologies.

The alkene functional monomers can be selected to achieve any of the above applications and properties of the thiolene polymer.

### REFERENCES

The following references are incorporated by reference herein.
(1) Hoyle, C. E.; Lee, T. Y.; Roper, T. J. Polym. Sci. Part A Polym. Chem. 2004, 42, 5301-5338.
(2) Gates, B. D.; Xu, Q.; Stewart, M.; Ryan, D.; Willson, C. G.; Whitesides, G. M. Chem. Rev. 2005, 105, 1171-1196.
(3) Hagberg, E. C.; Malkoch, M.; Ling, Y.; Hawker, C. J.; Carter, K. R. Nano Lett. 2007, 7, 233-237.
(4) Schmid, H.; Michel, B. Macromolecules 2000, 33, 3042-3049.
(5) Odom, T. W.; Love, J. C.; Wolfe, D. B.; Paul, K. E.; Whitesides, G. M. Langmuir 2002, 18, 5314-5320.
(6) Rolland, J. P. J. Am. Chem. Soc. 2004, 126, 2322-2323.
(7) Choi, K. M.; Rogers, J. A. J. Am. Chem. Soc. 2003, 125, 4060.
(8) Choi, S.; Yoo, P. J.; Baek, S. J.; Kim, T. W.; Lee, H. H. J. Am. Chem. Soc. 2004, 126, 7744-7745.
(9) Truong, T. T.; Lin, R.; Jeon, S.; Lee, H. H.; Maria, J.; Gaur, A.; Hua, F.; Meinel, I.; Rogers, J. A. Langmuir 2007.
(10) Truong, T. T.; Lin, R.; Jeon, S.; Lee, H. H.; Maria, J.; Gaur, A.; Hua, F.; Meinel, I.; Rogers, J. A. Langmuir 2007, 23, 2898-2905.
(11) Gates, B. D.; Whitesides, G. M. J. Am. Chem. Soc. 2003, 125, 14986-14987.
(12) Li, H. W.; Muir, B. V. O.; Fichet, G.; Huck, W. T. S. Langmuir 2003, 19, 1963-1965.
(13) Hui, C. Y.; Jagota, A.; Lin, Y. Y.; Kramer, E. J. Langmuir 2002, 18, 1394-1407.
(14) Lee, J. N.; Park, C.; Whitesides, G. M. Anal Chem. 2003, 75, 6544-6554.
(15) Hoyle, C. E.; Lee, T. Y.; Roper, T. J. Polym. Sci., Part A: Polym. Chem. 2004, 42, 5301-5338.
(16) Chou, S. Y.; Krauss, P. R.; Renstrom, P. J. Science 1996, 272, 85-87.
(17) Kim, E.; Xia, Y.; Zhao, X. M.; Whitesides, G. M. Adv. Mater. 1997, 9.
(18) Johnson Jr., R. T.; Biefeld, R. M.; Sayre, J. A. Polym. Eng. Sci. 1984, 24, 435-441.
(19) Colburn, M.; Johnson, S. C.; Stewart, M. D.; Damle, S.; Bailey, T. C.; Choi, B.; Wedlake, M.; Michaelson, T. B.; Sreenivasan, S. V.; Ekerdt, J. G.; Willson, C. G. Proc. SPIE 1999, 3676 379-389.
(20) Eunha, K.; Jamieson, A. T.; Stacey, N. A.; Ekerdt, J. G.; Willson, C. G.; Mancini, D. P.; Dauksher, W. J.; Nordquist, K. J.; Resnick, D. J. Proc. SPIE 2003, 5037, 197-202.
(21) Goh, C.; Coakley, K. M.; McGehee, M. D. Nano Lett. 2005, 5, 1545-1549.
(22) Zhang, Y.; Lo, C. W.; Taylor, J. A.; Yang, S. Langmuir 2006, 22, 8595-8601.
(23) The physical toughness is defined as the area under the stress-strain curve of the material.
(24) Donzel, C.; Geissler, M.; Bernard, A.; Wolf, H.; Michel, B.; Hilborn, J.; Delamarche, E. Adv. Mater. 2001, 13, 1164-1167.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A thiol-ene polymer composition of matter, comprising:
a reaction mixture of one or more poly-thiol compounds blended with one or more alkene-functional monomers; and
a cross-linking between the alkene-functional monomers and the poly-thiol compounds that controls one or more physical properties of the thiol-ene polymer.

2. The composition of matter of claim 1, wherein the poly-thiol compounds comprise thiolpropyl substituted poly(mercaptopropylmethylsiloxane) (PMMS).

3. The composition of matter of claim 2, wherein the physical properties are a tunable Young's modulus, hydro-phobicity or hydro-philicity.

4. The composition of matter of claim 1, wherein the alkene-functional monomers comprise one or more of the following: ethylene glycol diacrylate (EGDA), 2,4,6-triallyloxy-1,3,5-triazine (TAOTA), and Ethoxylated (4) bisphenol A dimethacrylate (BPADMA).

5. The composition of matter of claim 1, wherein the physical properties are controlled by one or more of the following: a composition of the alkene monomers, an alkene monomer to thiol weight to weight ratio (ene:thiol ratio), a structure of the alkene monomers and physical properties of the alkene functional monomers.

6. The composition of matter of claim 1, wherein the physical properties enable the thiol-ene polymer to be molded into submicron and nano scale features with aspect ratios of up to 5 without collapse of the features.

7. The composition of matter of claim 1, wherein a first composition of one of the alkene monomers allows the thiol-ene polymer to withstand a stress greater than 1 MPa.

8. The composition of matter of claim 7, wherein a second composition of one of the alkene monomers allows the thiol-ene polymer to have a strain percentage (change in length divided by original length multiplied by 100) between 5% and 55%.

9. The composition of matter of claim 1, wherein a composition of the alkene monomers achieves a hydrophobicity for the thiol-ene compound.

10. The composition of matter of claim 1, wherein a composition of the alkene monomers allows the thiol-ene polymer to be cured at temperatures up to at least 225° C.

11. The composition of matter of claim 1, wherein a composition of the alkene monomers renders the thiol-ene polymer transparent for wavelengths of light above 300 nm.

12. The composition of matter of claim 1, wherein a composition of a one of the alkene monomers renders the alkene monomers and the poly-thiol compound miscible.

13. The composition of matter of claim 1, wherein the alkene monomers comprise Ethoxylated (4) bisphenol A dimethacrylate (BPADMA) to increase a stress the thiolene polymer can withstand without breaking, as compared to without the BPADMA.

14. The composition of matter of claim 13, wherein the alkene monomers further comprise ethylene glycol diacrylate (EGDA) to increase a flexibility of the thiol-ene polymer as compared to without the EGDA.

15. The composition of matter of claim 13, wherein the alkene monomers further comprise 2,4,6-triallyloxy-1,3,5-triazine (TAOTA) to render the BPADMA and the poly thiol compound comprising PMMS miscible.

16. An apparatus for use in lithography, comprising:
a stamp comprised of a patterned thiol-ene polymer, wherein the patterned thiol-ene polymer allows for creation of micro-scale or nano-scale patterns useful in soft or imprint lithography.

17. The apparatus of claim 16, wherein the thiol-ene polymer is a thiol-ene based polyalkylsiloxane material.

18. The apparatus of claim 17, wherein the thiol-ene polymer comprises thiolpropyl substituted poly(mercaptopropylmethylsiloxane) (PMMS).

19. The apparatus of claim 16, wherein the thiol-ene polymer is made from a reaction mixture comprising poly-thiol compounds blended with alkene-functional monomers to produce the thiol-ene polymer, wherein the polymer achieves a cross linking that controls physical properties of the thiol-ene polymer.

20. A method for fabricating a thiol-ene polymer, comprising
(a) mixing one or more poly thiol compounds and one or more alkene-functional monomers in the presence of less than 0.1% of a radical photoinitiator; and
(b) cross-linking the one or more thiol compounds and the one or more alkene-functional monomers, via radical addition to double bonds and radical-radical recombinations, thereby forming the thiol-ene polymer.

21. The method of claim 20, wherein the cross-linking is achieved through a photochemical process and in a presence of oxygen.

22. The method of claim 20, further comprising screening the alkene functional monomers to control physical properties of the thiol-ene polymer.

23. The method of claim 20, wherein the cross-linking is achieved thermally.

24. A method of fabricating a patterned thiol-ene polymer, comprising:
(a) casting a thiol-ene mixture onto a patterned mold;
(b) curing the thiol-ene mixture to form the patterned thiol-ene polymer; and
(c) peeling off the patterned thiol-ene polymer from the mold.

25. A method for replicating a stamp comprised of a thiol-ene polymer, comprising:
(a) exposing a stamp comprised of a thiol-ene polymer to oxygen plasma or ozonolysis to form a hydrophilic mold;
(b) exposing the hydrophilic mold to a fluorinating agent to form a functionalized surface of the hydrophilic mold;
(c) casting a thiol-ene mixture on top of the functionalized surface;
(d) photocuring the thiolene mixture to form a replica thiol-ene polymer; and
(e) peeling off the replica thiol-ene polymer from the functionalized surface of the hydrophilic mold.

26. The method of claim 25, wherein the functionalized surface is a hydrophobic surface.
